(19) United States
(12) Patent Application Publication
(10) Pub. No.: US 2016/0061432 A1
(43) Pub. Date: Mar. 3, 2016

(54) ENCAPSULATED LOW VOLTAGE LED LIGHTING SYSTEM

(71) Applicant: INTEGRO, LLC, New Britain, CT (US)

(72) Inventors: John Bogart, Oxford, CT (US); Frank Cassandra, Lake Worth, FL (US)

(73) Assignee: INTEGRO, LLC, New Britain, CT (US)

(21) Appl. No.: 14/835,893

(22) Filed: Aug. 26, 2015

Related U.S. Application Data
(63) Continuation-in-part of application No. 13/758,542, filed on Feb. 4, 2013, now abandoned.
(60) Provisional application No. 61/594,500, filed on Feb. 3, 2012.
(60) Provisional application No. 61/721,718, filed on Nov. 2, 2012.
(60) Provisional application No. 61/731,931, filed on Nov. 30, 2012.

(51) Int. Cl. F21V 23/06; H01R 4/24; H05B 33/08

(52) U.S. Cl. CPC F21V 23/06; H05B 33/0809; H01R 4/2404

(57) ABSTRACT

A lighting streamer for a low voltage LED lighting system includes a cable having a positive conductor and a negative conductor, a first connector, a second connector, and at least one socket assembly positioned between the first connector and the second connector and in electrical communication with the cable. Each of the socket assemblies are configured to receive an LED bulb therein. The socket assembly defines a top portion and a bottom portion which when assembled, pierce the positive conductor and the negative conductor. A protective coating encapsulates the at least one socket assembly. At least one LED light bulb positioned in and in electrical communication with the at least one socket.

### CROSS-REFERENCE TO RELATED APPLICATIONS

This application is a Continuation-In Part of U.S. patent application Ser. No. 13/758,542 filed on Feb. 4, 2013, and claims the benefit of such application, and thus this application claims the benefit of each of the following U.S. Provisional Patent Applications, each of which is incorporated herein by reference in its entirety: (i) U.S. Provisional Patent Application Ser. No. 61/594,500; filed on Feb. 3, 2012; (ii) U.S. Provisional Patent Application Ser. No. 61/721,718; filed on Nov. 2, 2012; and (iii) U.S. Provisional Patent Application Ser. No. 61/731,931; filed on Nov. 30, 2012.

### TECHNICAL FIELD

The present invention is directed to low voltage lighting systems and, more particularly, to an encapsulated low voltage lighting system used in facilities' lighting and in temporary lighting systems.

### BACKGROUND

Existing electrical wiring at facilities typically require that power circuits are brought geographically throughout the facility. For example, a single circuit breaker may be dedicated to an area of offices and provide power for wall outlets, computers, copiers, printers and other office equipment, as well as lights. All of the equipment, including incandescent lights, are designed for and draw power from the sole source. Light Emitting Diode (“LED”) lights have been available to replace incandescent lights; however, LED lights inherently are designed to operate off of a Direct Current (DC) circuit. A preferred power source for LED's is much like household batteries. The power is designed to originate at the source and travel to the application. Alternatively, Alternating Current (AC) circuits deliver power from the source to the application as well as delivering power downline to the next series of applications. Substantially the entire electrical infrastructure of existing facilities is wired via AC circuits. Therefore, a move to LED lighting products within an existing AC infrastructure requires some type of conversion of the power infrastructure.

LED lighting bulbs have been developed for use with existing electrical infrastructures. These commercially available bulbs come with an AC/DC converter built into them. They are designed to plug into standard one hundred twenty volt AC (120 VAC) lighting sockets that were originally designed for incandescent bulbs. The electronics built into the LED bulb convert the energy from AC to DC power for use with the LED bulb. However, the AC/DC conversion device built into the LED bulb, such as a bridge rectifier, does not allow the light bulb to operate at maximum efficiency. The micro processor performing the conversion generally consumes more energy (e.g., watts) than the actual light requires.

The total amount of light produced by a light source such as an incandescent bulb or an LED bulb, without regard to direction, is measured in lumens. The amount of light produced by the light source in a specific direction is measured in candela and is graphically represented by polar-formatted charts that indicate the intensity of light at each angle away from 0° lamp axis. The 0° lamp axis is often referred to as the “nadir,” which represents the direction pointing directly below a particular light source, and the tabular form typically includes candela output at n° wherein n represents an angle measured from the 0° lamp axis (i.e., from the direction pointing directly below a particular light source) and such angle can range from one side of the light source to the other side of the light source, from −90° to +90°.

The enclosures for standard electrical equipment, such as for example an AC/DC conversion device or a light bulb, are designed to prevent debris and moisture from entering therein, and are rated for a sealing effectiveness of such enclosures. Some industry standards have been adopted for water protection specifications for electrical device enclosures and are referred to herein. One such European Community Specification, IEC 529, provides a classification system for Ingress Protection, IP##. The first digit indicates the degree the enclosure is protected against the ingress of solid materials and ranges from 0 (no protection) to 6 (dust-tight). The second digit indicates the degree the enclosure is protected against the ingress of moisture and ranges from 0 (no protection) to 8 (protected against submersion). For example, a rating of IP64 indicates that such an enclosure exhibits an Ingress Protection that is dust-tight and protected against splashing water from all directions; while a rating of IP67 indicates that such an enclosure exhibits an Ingress Protection that is dust-tight and protected against the effects of short-term immersion. Other industry standards that have been adopted include specifications promulgated by the Federal Aviation Administration (“FAA”). Such specifications are referred to herein as FAA Specifications.

In one application, a thirteen watt (13 W) LED bulb is used to generate the light output of a sixty watt (60 W) incandescent bulb. It appears that approximately three watts of energy are dedicated to the light output for the LED bulb, while the remaining power is lost in the AC/DC conversion. Harmonic issues also exist when converting from AC to DC which tends to make the lights hum while operating. In addition, LED light bulbs that have AC/DC conversion built into them tend to burn hot. Many of the manufacturers build heat sinks into such bulbs to dissipate the heat. However, such heat still presents a less-safe environment and lessens the life of the bulb and the socket. Moreover, because these bulbs still operate with a one hundred twenty volt AC (120 VAC) socket, a shock hazard remains if a person comes in contact with a live socket. The risk of shock is not alleviated by replacing the incandescent bulb with a standard off-the-shelf LED bulb.

Current temporary lighting systems, commonly referred to as lighting streamers, used during heavy construction activities typically employ incandescent light bulbs on twenty amp, one hundred twenty volt AC (20 A, 120 VAC) circuits. Various construction project locations have adopted different standards regarding the use of particular wattage bulbs and the distance between sockets. Such standards commonly require the use of sixty watt (60 W) bulbs, seventy-five watt (75 W) bulbs and/or one hundred watt (100 W) bulbs. Common distances between sockets positioned on the lighting streamers include five feet (5′) and ten feet (10′) intervals.

One known prior art lighting streamer system extends for a length of fifty feet (50′) and includes ten (10) sockets on five foot (5′) centers. The lighting streamers are designed to interconnect or daisy-chain several fifty foot (50′) sections together. Using seventy-five watt (75 W) bulbs, each bulb requires a nominal current of 0.625 Amps (75 W/120V). At a max loading of 80%, thereby accounting for line loss over distance and power factor efficiencies at each light bulb, the maximum amount of seventy-five watt (75 W) bulbs that can be served by one twenty amp/one hundred twenty volt (20 A, 120V) power source is twenty-six (26) bulbs (20 A×80%=16 A; 16 A/0.625 A/bulb=25.6 bulbs).

Several issues arise with the use of the prior art lighting streamer system. Incandescent light bulbs are becoming obsolete and such bulbs become extremely hot due to the nature of their inefficiency. The life expectancy of such bulbs is short which requires higher maintenance costs. A system rated at one hundred twenty volts AC (120 VAC) presents a shock hazard per the guidelines and safety codes issued by the Occupational Safety and Health Administration (“OSHA”); and pursuant to such safety codes, ground fault circuit interrupter (“GFCI”) protection must be employed which increases the capital cost of such prior art lighting streamer systems. Additional problems have been noted with the use of GFCI in the prior art lighting streamer systems. If a ground fault occurs, the entire lighting system on the particular circuit will shut down. Therefore, a workforce can be placed in a very dangerous work environment having no light therein. To address this danger, very expensive and redundant emergency lighting systems are installed.

The use of LED bulbs in prior art lighting streamer system requires an increased investment per bulb; therefore, protecting the LED bulbs, or making the LED bulbs outdoor-rated, is important for maximizing return-on-investment. However, the use of LED bulbs on the standard system is problematic in that a rectifier needs to be built into each bulb to convert AC to DC at each socket with potential for harmonic issues. Rectifiers found in off-the-shelf LED bulbs typically consume three-times more energy than the actual LED bulbs consume for lighting which results in an inefficient solution.

### SUMMARY

In one aspect, the present invention resides in a lighting streamer for a low voltage LED lighting system, the lighting streamer comprising: a cable having a first end and a second end, the cable including a positive conductor and a negative conductor; a first connector positioned on and in electrical communication with the first end of the cable; a second connector positioned on and in electrical communication with the second end of the cable; at least one socket assembly positioned between the first connector and the second connector and in electrical communication with the cable, the socket assembly defining a top portion and a bottom portion which when assembled, pierce the positive conductor and the negative conductor and place a positive contact in electrical communication with the positive conductor and place a negative contact in electrical communication with the negative conductor, each of the at least one socket assemblies being configured to receive an LED bulb therein; and a protective coating encapsulating the at least one socket assembly.

In another aspect, the present invention resides in a lighting streamer for a low voltage LED lighting system, the lighting streamer comprising: a cable having a first end and a second end, the cable including a positive conductor and a negative conductor; a first connector positioned on and in electrical communication with the first end of the cable; a second connector positioned on and in electrical communication with the second end of the cable; a plurality of socket assemblies positioned between the first connector and the second connector and in electrical communication with the cable, each of the socket assemblies defining a top portion and a bottom portion which when assembled, pierce the positive conductor and the negative conductor and place a positive contact in electrical communication with the positive conductor and place a negative contact in electrical communication with the negative conductor, each of the at least one socket assemblies being configured to receive an LED bulb therein, each of the socket assemblies comprising, a socket base, a socket cap; a positive contact terminal point of the positive contact extending through the socket base toward the socket cap and in electrical communication with the positive conductor, a negative contact terminal point of the negative contact extending through the socket base toward the socket cap and in electrical communication with the negative conductor, a first slot defined in the socket cap configured for receiving the positive contact therethrough, and a second slot defined in the socket cap configured for receiving the negative contact therethrough; a locking mechanism configured to releasably detach the top portion from the bottom portion; and a protective coating encapsulating each of the socket assemblies.

In another aspect, the present invention resides in a low voltage LED lighting system comprising: a power supply; an AC/DC converter in electrical communication with the power supply; a cable having a first end and a second end, the cable including a positive conductor and a negative conductor, the cable in electrical communication with the AC/DC converter; a first connector positioned on and in electrical communication with the first end of the cable; a second connector positioned on and in electrical communication with the second end of the cable; a plurality of socket assemblies positioned between the first connector and the second connector and in electrical communication with the cable, each of the at least one socket assemblies being configured to receive an LED bulb therein, each of the socket assemblies defining a top portion and a bottom portion which when assembled, pierce the positive conductor and the negative conductor and place a positive contact in electrical communication with the positive conductor and place a negative contact in electrical communication with the negative conductor, each of the socket assemblies comprising, a socket base, a socket cap, a positive contact terminal point of the positive contact extending through the socket base toward the socket cap and in electrical communication with the positive conductor, a negative contact terminal point of the negative contact extending through the socket base toward the socket cap and in electrical communication with the negative conductor, a first slot defined in the socket cap configured for receiving the positive contact therethrough, and a second slot defined in the socket cap configured for receiving the negative contact therethrough; a locking mechanism configured to releasably detach the top portion from the bottom portion; and a protective coating encapsulating each of the socket assemblies.

### BRIEF DESCRIPTION OF THE DRAWINGS

FIG. 1 is a schematic diagram of one embodiment of a low voltage LED lighting system of the present invention.

FIG. 2 is a schematic diagram of a lighting streamer of the LED temporary lighting system of FIG. 1.

FIG. 3 is a schematic diagram of one molded connector of the lighting streamer of FIG. 2.

FIG. 4 is a schematic diagram of another molded connector of the lighting streamer of FIG. 2.

FIG. 5 is a diagram of an LED light bulb of the LED temporary lighting system of FIG. 1.

FIG. 6 is schematic diagram of another embodiment of a low voltage LED lighting system of the present invention.

FIGS. 7A-7D provide a photometric chart identified as Table 1, respectively presented in Parts 1-4, and encompassing a comparison of the performance of selected incandescent and LED bulbs.

FIGS. 8A-8C provide a usage table, identified as Table 2, respectively presented in Parts 1-3, and encompassing a comparison of the cost of using selected incandescent and LED bulbs.

FIG. 9 is a schematic diagram of a lighting streamer of the LED temporary lighting system of FIG. 1.

FIG. 10A is a front elevation view of a molded socket of the lighting streamer of FIG. 9.

FIG. 10B is a top view of the molded socket of FIG. 10A.

FIG. 10C is a side elevation view of the molded socket of FIG. 10B.

FIG. 10D is a sectional view of the molded socket of FIG. 10A taken along line A-A of FIG. 10B.

FIG. 11A is a view of the cable of the lighting streamer of FIG. 9 having a portion of the insulation removed for mounting of the molded socket of FIG. 10A thereon.

FIG. 11B is a side elevation view of portions of the molded socket of FIG. 10A to be mounted on the cable of FIG. 11A.

FIG. 11C is a top view of the cable of FIG. 11A fitted onto a portion of the molded socket of FIG. 10A.

FIG. 11D is an end view of the cable of FIG. 11A fitted onto a portion of the molded socket of FIG. 10A.

FIG. 12 is an isometric view of a portion of the molded socket of the lighting streamer of FIG. 9.

FIG. 13A is a front elevation view of a bottom portion of the molded socket of the lighting streamer of FIG. 9.

FIG. 13B is a top view of the bottom portion of the molded socket of FIG. 13A.

FIG. 13C is a bottom view of the bottom portion of the molded socket of FIG. 13A.

FIG. 13D is a side elevation view of the bottom portion of the molded socket of FIG. 13A.

FIG. 13E is a sectional view of the bottom portion of the molded socket of FIG. 13A taken along line E-E of FIG. 13B.

FIG. 14 is an isometric view of a socket base portion of the molded socket of the lighting streamer of FIG. 9.

FIG. 15A is a front elevation view of the socket base portion of FIG. 14.

FIG. 15B is a top view of the socket base portion of FIG. 14.

FIG. 15C is a bottom view of the socket base portion of FIG. 14.

FIG. 15D is a side elevation view of the socket base portion of FIG. 14.

FIG. 15E is a sectional view of the socket base portion of FIG. 14 taken along line E-E of FIG. 15B.

FIG. 16 is an isometric view of a socket cap portion of the molded socket of the lighting streamer of FIG. 9.

FIG. 17A is a front elevation view of the socket cap portion of FIG. 16.

FIG. 17B is a top view of the socket cap portion of FIG. 16.

FIG. 17C is a bottom view of the socket cap portion of FIG. 16.

FIG. 17D is a side elevation view of the socket cap portion of FIG. 16.

FIG. 17E is another side elevation view of the socket cap portion of FIG. 16.

FIG. 18 is an isometric view of a positive contact of the molded socket of the lighting streamer of FIG. 9.

FIG. 19A is a front elevation view of the positive contact of FIG. 18.

FIG. 19B is a top view of the positive contact of FIG. 18.

FIG. 19C is a side elevation view of the positive contact of FIG. 18.

FIG. 20 is an isometric view of a negative contact of the molded socket of the lighting streamer of FIG. 9.

FIG. 21A is a front elevation view of the negative contact of FIG. 20.

FIG. 21B is a top view of the negative contact of FIG. 20.

FIG. 21C is a side elevation view of the negative contact of FIG. 20.

FIG. 22 is an isometric view of a top portion of the molded socket of the lighting streamer of FIG. 9.

FIG. 23A is a front elevation view of the top portion of FIG. 22.

FIG. 23B is a top view of the top portion of FIG. 22.

FIG. 23C is a bottom view of the top portion of FIG. 22.

FIG. 23D is a side elevation view of the top portion of FIG. 22.

### DETAILED DESCRIPTION

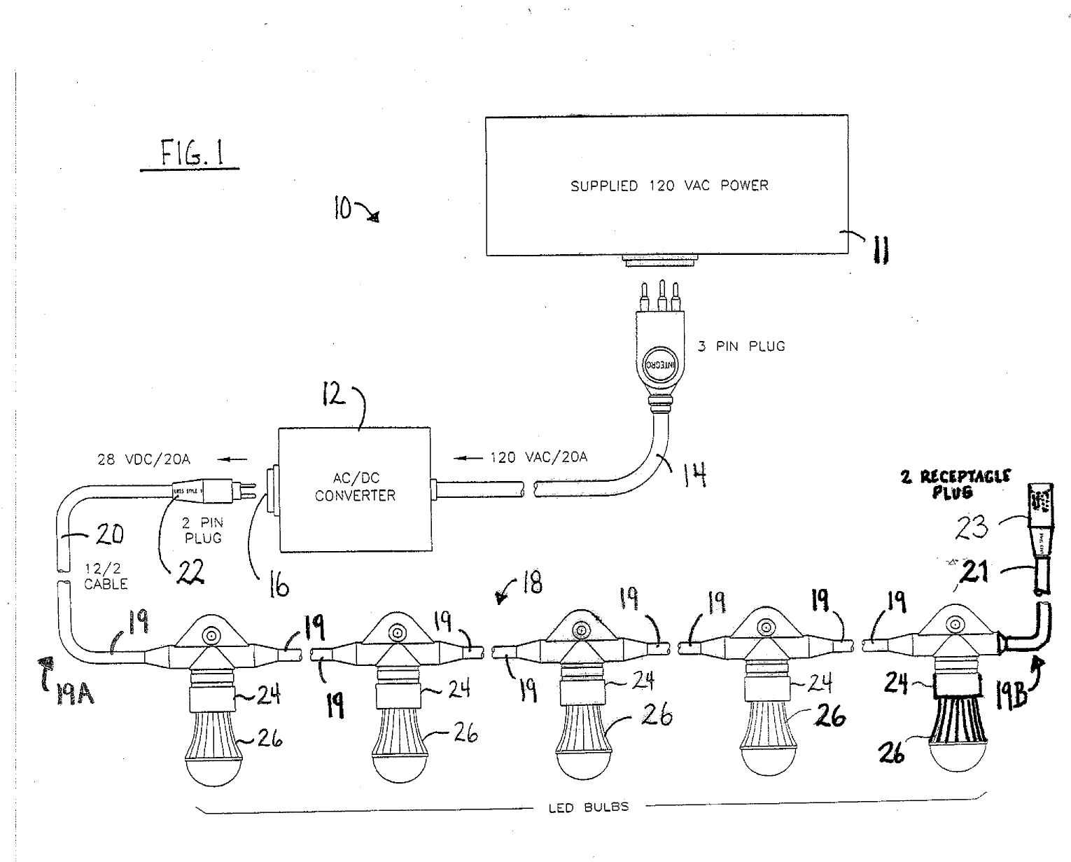

A Low Voltage LED Lighting System 10 in accordance with one embodiment of the present invention is designated generally by the reference number 10 and is hereinafter referred to as “lighting system 10.” The lighting system 10 is designed to retrofit a prior art lighting streamer system having an existing twenty amp, one hundred twenty volt AC (20 A, 120 VAC) readily available power source. As depicted in FIG. 1, lighting system 10 draws power from a standard one hundred twenty volt AC (120 VAC) power supply 11. An AC/DC Converter 12 draws power from the power supply 11 via a power input cord 14 and defines at least one outlet 16. The power input cord 14 may be fabricated from standard electrical cable (e.g., 12/3 cable) and includes, in one embodiment, a molded male connector or an equivalent assembled one hundred twenty volt AC (120 VAC) connector.

Lighting system 10 further includes a lighting streamer 18. The lighting streamer 18 comprises a cable 19 that includes an input lead 20 with a permanently molded first connector 22 on a first end 19A and an output lead 21 with a permanently molded second connector 23 on a second end 19B. It should be appreciated that the lighting streamer 18 distributes power to components, described below, in electrical communication with the lighting streamer 18. Lighting streamer 18 includes multiple permanently molded sockets 24 located at, for example, five foot (5′) centers and in electrical communication with the lighting streamer 18. Lighting system 10 further includes LED light bulbs 26 connected to and extending from sockets 24. Lighting streamers 18 can measure twenty-five feet (25′), fifty feet (50′), or other lengths, preferably in increments of five feet (5′) to accommodate having molded sockets (24 located on five foot (5′) centers. Lighting streamers 18 may be fabricated from any two-conductor electrical cable suitable for distributing power, such as for example electrical cable ranging in size and scope commensurate with 24AWG to 10AWG electrical cable.

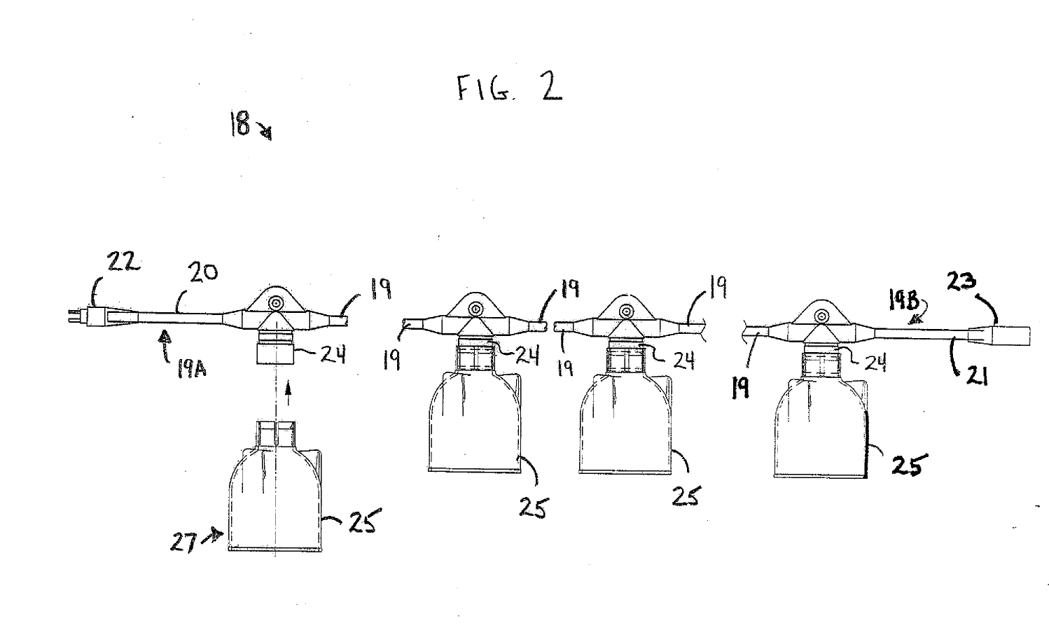

As shown in FIG. 2, each of the sockets 24 for the LED bulbs 26 (FIG. 1) can selectively include a guard 25 to protect the LED light bulb 26. Alternatively, the LED light bulb 26 and the guard 25 may form a bulb/guard assembly 27. In one embodiment, the guard 25 comprises a mesh fabricated from a polycarbonate polymer such as polycarbonate resin thermoplastic, such as for example Lexan®, a registered trademark of Sabic Innovative Plastics Company of The Netherlands. The Lexan® type guard comprises a specially designed louver system to provide maximum weather protection while allowing light to breathe and exhaust any heat generated. In another embodiment, the guard 25 comprises a coated steel wire mesh that provides more strength and superior heat exhaust features, yet the bulb is more exposed to moisture.

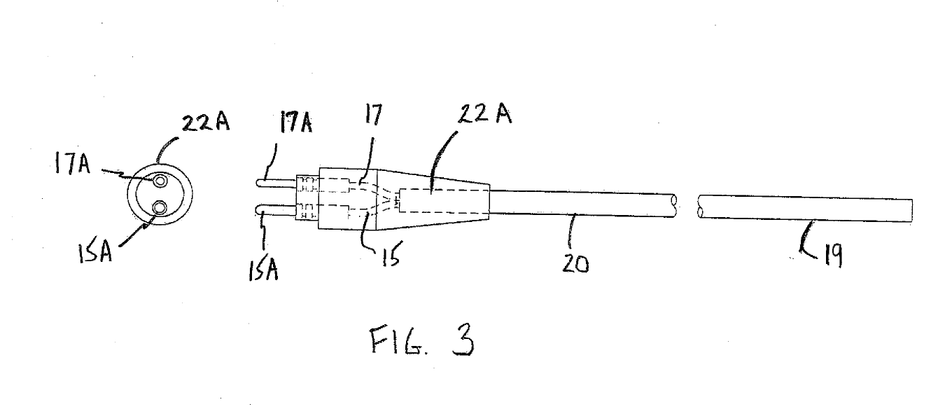

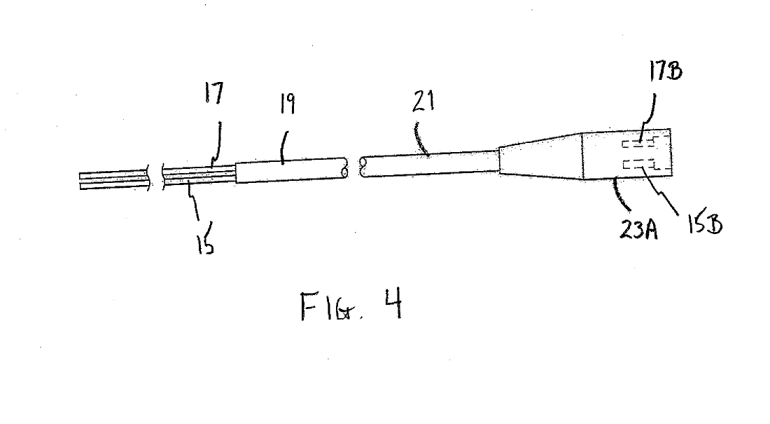

The cable 19 provides DC current to the lighting streamer 18. As shown in FIGS. 3 and 4, in one embodiment, the input lead 20 of cable 19 terminates in a permanently molded 2-pin male connector 22A, and the output lead 21 of cable 19 with a permanently molded 2 pin female connector 23A. This configuration accommodates having multiple lighting streamers that may be daisy-chain connected wherein the female connector 23A of the output lead 21 of a first lighting streamer 18 may receive the male connector 22A of the input lead 20 of a second lighting streamer 18 to distribute power between the first and the second lighting streamers 18. The lighting system 10 can selectively define various lengths such as for example, a twenty-five foot (25′) length with five (5) sockets on five foot (5′) centers, or a fifty foot (50′) length with ten (10) sockets on five foot (5′) centers.

As further shown in FIGS. 3 and 4, the cable 19 includes two conductors or wires 15 and 17. In a DC circuit, one pole is always negative and the other pole is always positive such that the electrons flow in one direction only. In one embodiment, conductor 15 is a negative pole or conductor and conductor 17 is a positive pole or conductor. In one embodiment, the conductors 15 and 17 are sized differently or exhibit different colors to distinguish one conductor from the other. For example, in one embodiment, the negative conductor 15 is white and the positive conductor 17 is black. The conductor 15 defines a male terminus 15A and a female terminus or receptacle 15B. The conductor 17 defines a male terminus 17A and a female terminus or receptacle 17B. In one embodiment, the male and female terminuses 15A and 15B are sized differently to be distinguishable from the male and female terminuses 17A and 17B. For example, in one embodiment, the male and female terminuses 15A and 15B exhibit a larger diameter than the male and female terminuses 17A and 17B.

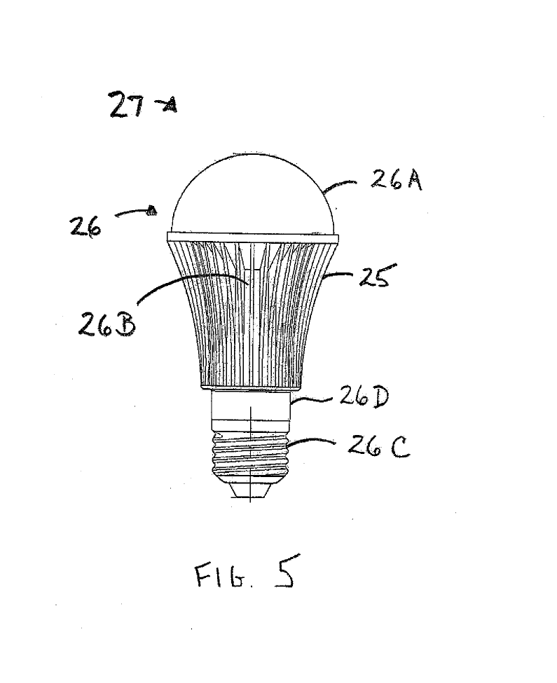

As shown in FIG. 5, lighting system 10 can selectively include LED bulbs 26 that define a plastic type/outdoor rated and waterproof protective cover that protects the LEDs. Examples include: (i) 2.8 W, 100 mA, 28 VDC; (ii) 4.2 W, 150 mA, 28 VDC; and (iii) 5.6 W, 200 mA, 28 VDC. The 2.8 W, 100 mA, 28 VDC rated LED bulbs have a life expectancy of 45,000 hours and 78.14 candela output at 0 degrees, which exceeds the values of the GE 60 W, 500 mA, 120 VAC soft white bulb (65.77 candela as measured in a lab). The 4.2 W, 150 mA, 28 VDC rated LED bulbs have a life expectancy of 45,000 hours and 105.75 candela output at 0 degrees, which exceeds the values of the GE 75 W, 625 mA, 120 VAC Crystal Clear bulb (103.48 candela as measured in a lab). The 5.6 W, 200 mA, 28 VDC rated LED bulbs have a life expectancy of 45,000 hours and 140.12 candela output at 0 degrees.

As further shown in FIG. 5, the bulb assembly 27 includes the LED bulb 26 and the guard 25. One embodiment of the LED bulb 26 comprises a protective cover 26A, a heat sink/base 26B, an Edison medium base right thread socket 26C and a ferrule 26D. One embodiment of the protective cover 26A is fabricated from frosted polycarbonate. One embodiment of the heat sink/base 26B is fabricated from anodized aluminum. One embodiment of the ferrule 26D is fabricated from polybutylene terephthalak (PBT). An embodiment of the LED bulbs 26 may comprise any combination of the described protective cover 26A, Heat Sink/Base 26B, Edison socket 26C and ferrule 26D. Preferably, the LED bulbs 26 have a minimum bulb life of 45,000 hours and exhibit a maximum temperature of 70° C. The LED bulbs 26 selectively comprise an E27 bulb base and are designed for use with a 28 VDC system power source. Such LED bulbs 26 weigh approximately 155 grams and are IP67 rated.

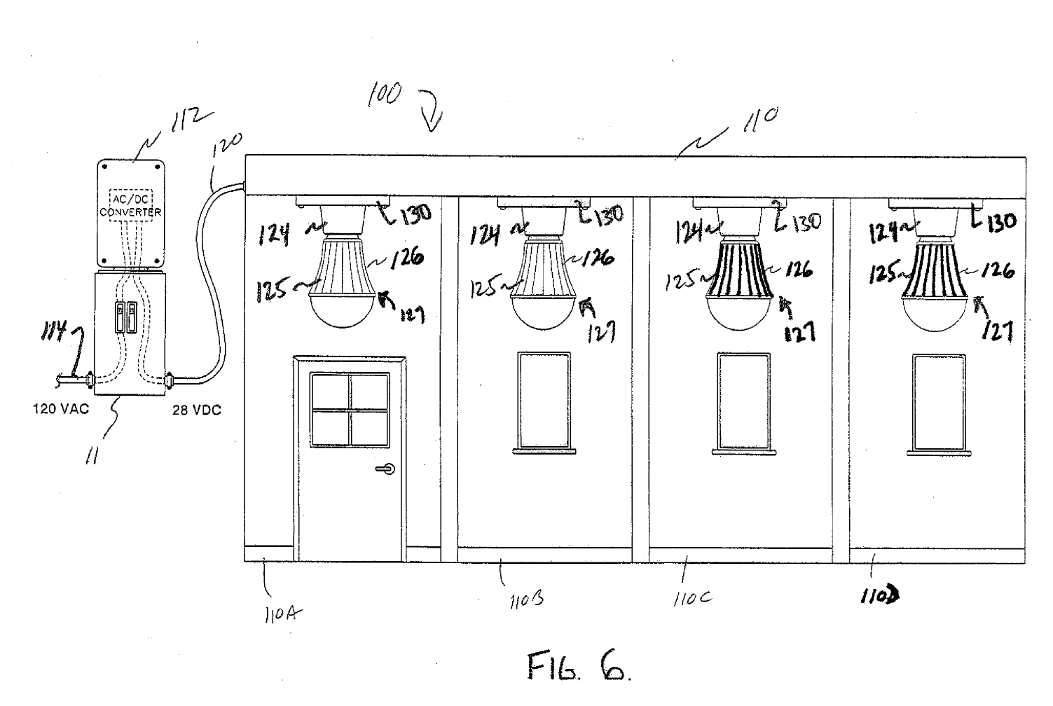

Another embodiment 100 of a low voltage LED lighting system is depicted in FIG. 6 wherein such lighting system 100 comprises facilities lighting. The lighting system 100 is similar to the lighting system 10 shown in FIG. 1, thus like elements are given a like element number preceded by the numeral 1.

As depicted in FIG. 6, lighting system 100 draws power from a standard one hundred twenty volt AC (120 VAC) power supply (not shown). An AC/DC Converter 112 draws power from the power supply via a power input cord 114 and provides 28 VDC. The lighting system 100 is installed in a facility 110 and includes an input lead 120 that distributes power to one or more sockets 124 in electrical communication therewith and extending from a mount 130 such as a ceiling mount positioned at respective locations of the facility, such as for example, locations 110A, 110B, 110C, and 110D. Lighting system 100 further includes LED light bulbs 126 connected to and extending from sockets 124. Each of the LED bulbs 126 can selectively define a guard 125 to protect the LED light bulb 126. Alternatively, the LED light bulb 126 and the guard 125 may form a bulb assembly 127.

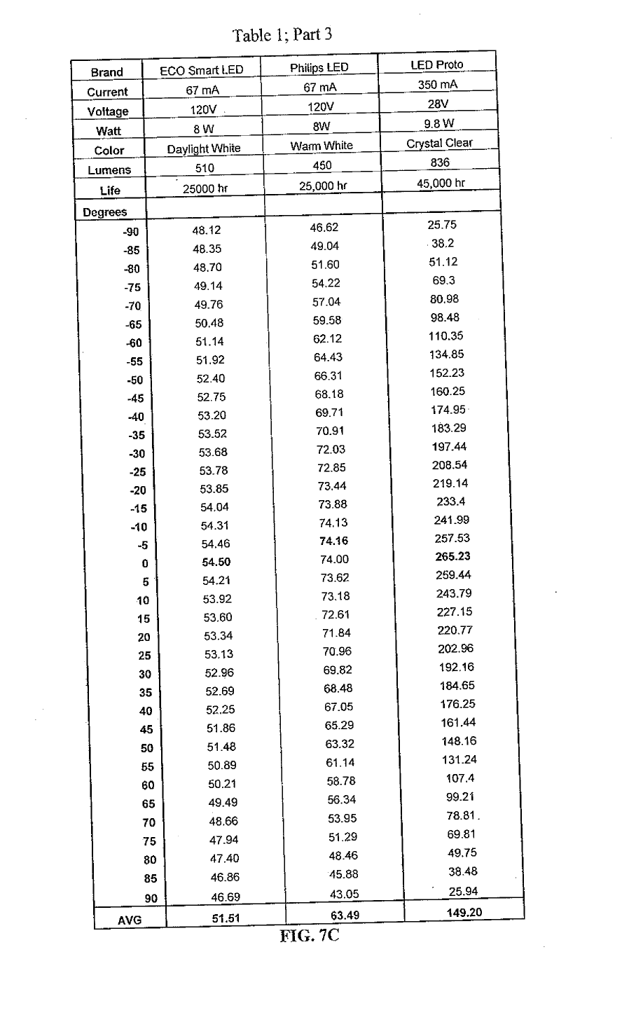

Another embodiment of a lighting system 10 includes a lighting streamer 218 shown in FIG. 9. The lighting streamer 218 comprises a cable 219 that includes an input lead 220 with a permanently molded first connector 222 on a first end 219A and an output lead 221 with a permanently molded second connector 223 on a second end 219B. Lighting streamer 218 includes multiple permanently molded sockets 224 in electrical communication with the cable 219. LED light bulbs 226 connected to and extending from sockets 224. Each of the LED bulbs 226 can selectively define a guard 225 to protect the LED light bulb 226. In one embodiment, the guards 225 include a guard cap 227 attached thereto. The cable 219 includes two conductors or wires 215 and 217. The conductor 215 defines a male terminus 215A and a female terminus or receptacle 215B. The conductor 217 defines a male terminus 217A and a female terminus or receptacle 217B.

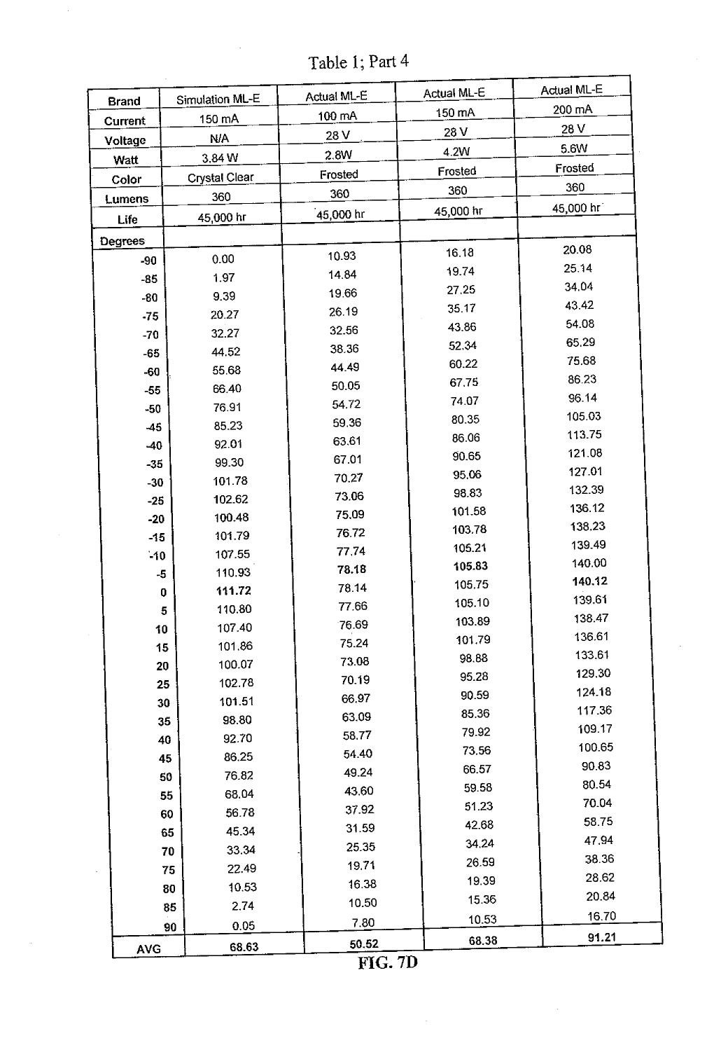

As shown in FIGS. 10A, 10B, 10C and 10D, each of the molded sockets 224 include a socket assembly 350 which is over-molded or encapsulated in a protective material 310. Such protective material 310 or coating may be for example a neoprene compound or a thermoplastic elastomer. In one embodiment, the protective material is Neoprene CL534. In one embodiment, the protective material is a Sarlink® TPE-V Product (Sarlink® is a registered trademark of Teknor Apex Company Corporation). In one embodiment, the cable 219 is encapsulated with the socket assembly 350 in the protective material 310. The molded socket 224 defines a top portion 312 and a bottom portion 314. In one embodiment, the molded socket 224 includes a grommet 313.

The molded socket defines a first length L1 and a first height H1. The top portion 312 defines a first width W1. The bottom portion 314 defines a first diameter D1 and a second diameter D2 where D2 is less than D1 to provide a gripping surface or ridges. In one embodiment, first length L1 is in the range of about 95 mm (about 3.75 inches) to about 108 mm (about 4.25 inches). In one embodiment, first length L1 is about 102 mm (about 4.0 inches). In one embodiment, first height H1 is in the range of about 95 mm (about 3.75 inches) to about 102 mm (about 4.0 inches). In one embodiment, first height H1 is about 97 mm (about 3.8 inches). In one embodiment, first width W1 is in the range of about 13 mm (about 0.5 inches) to about 25 mm (about 1.0 inch). In one embodiment, first width W1 is about 16 mm (about 0.63 inches). In one embodiment, first diameter D1 is in the range of about 44 mm (about 1.75 inches) to about 51 mm (about 2.0 inches). In one embodiment, first diameter D1 is about 47 mm (about 1.85 inches).

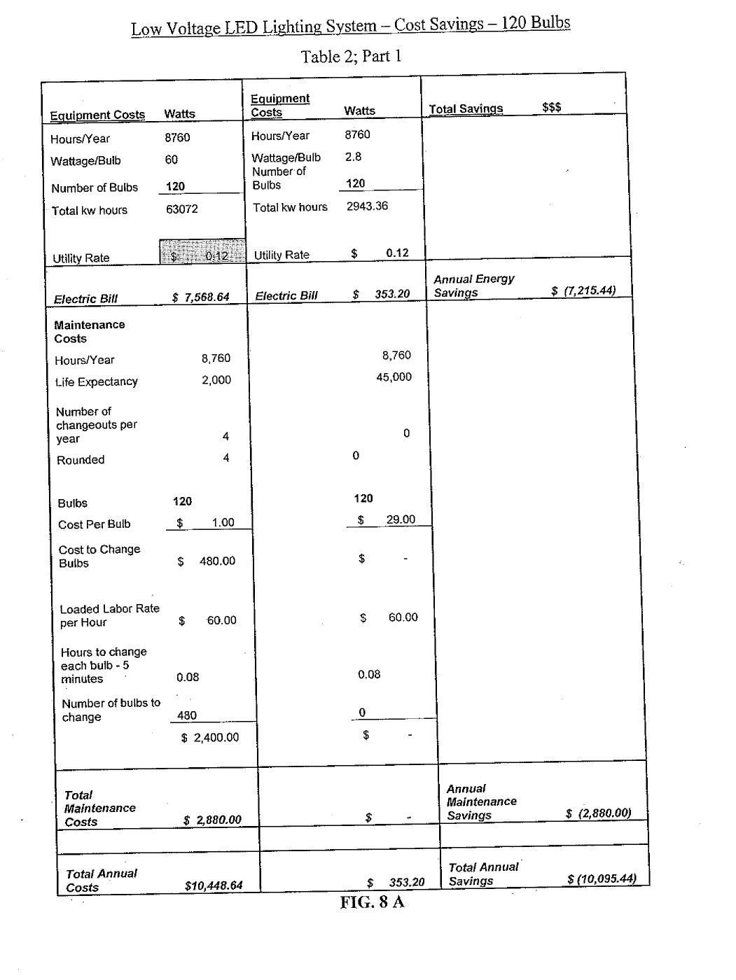

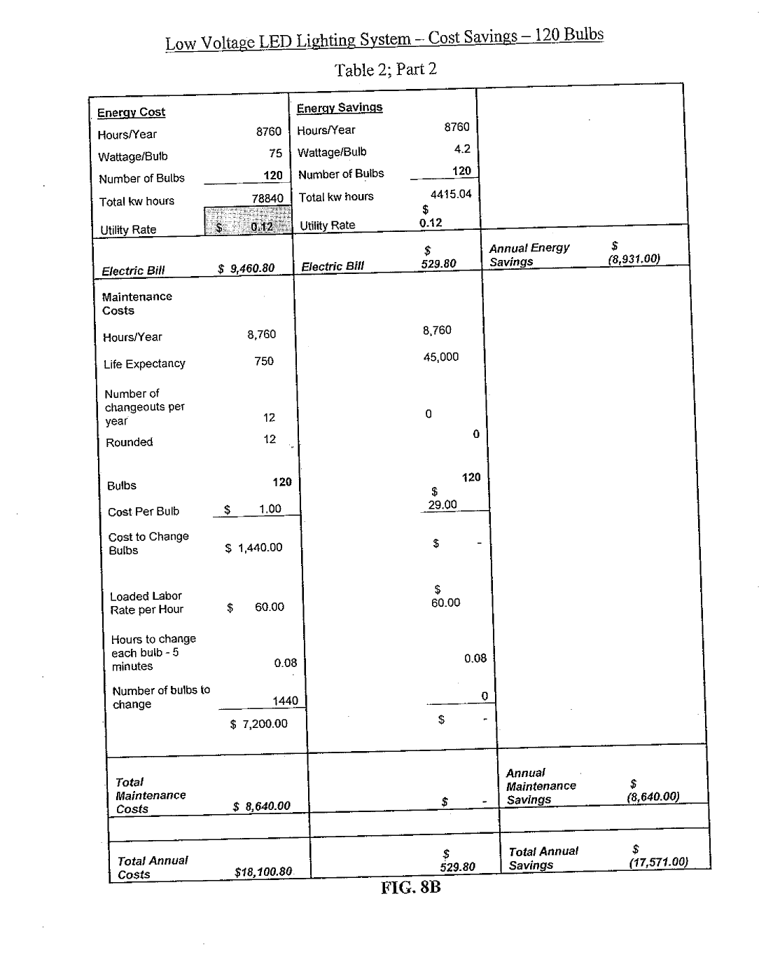

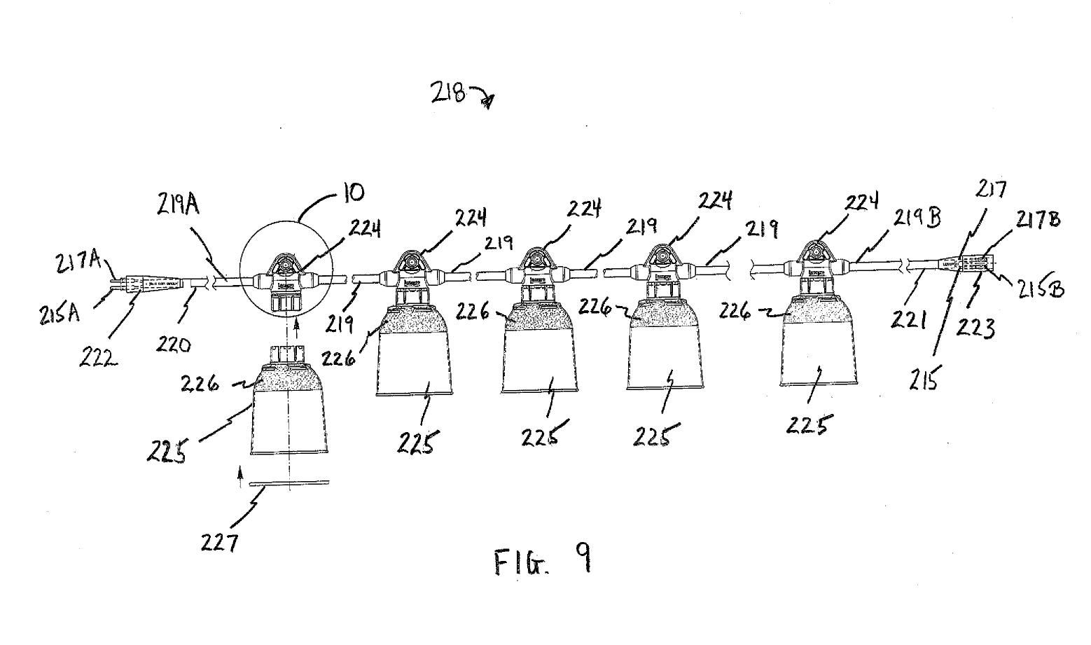

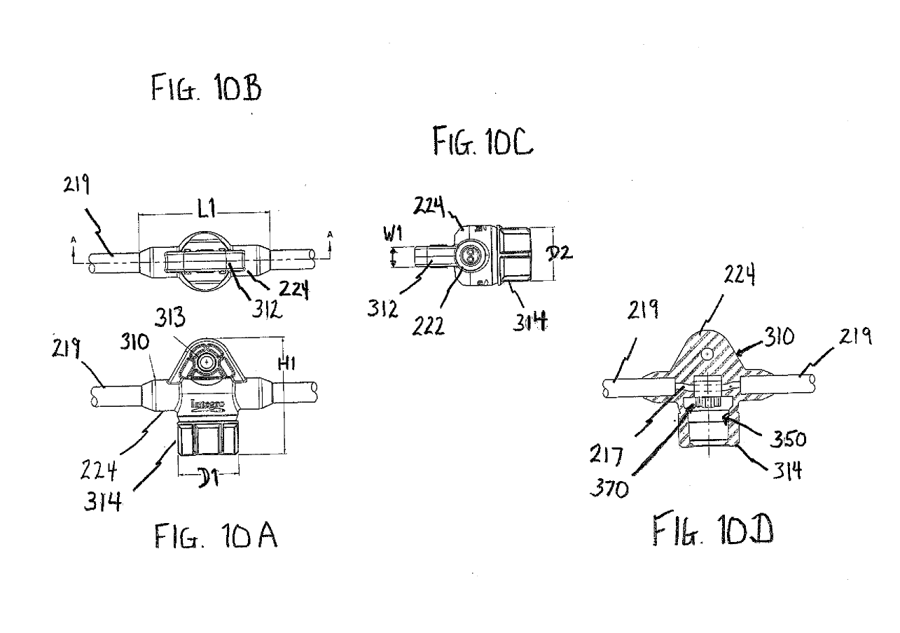

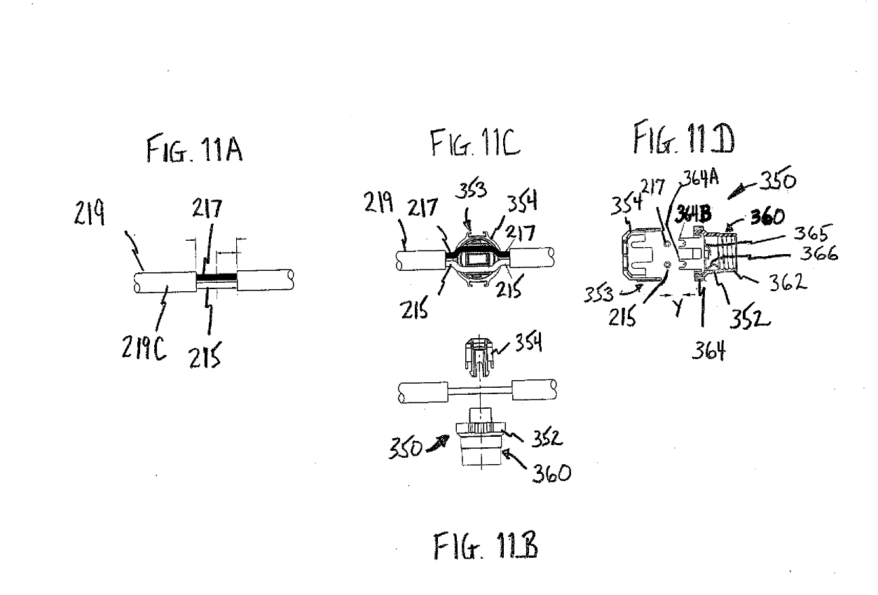

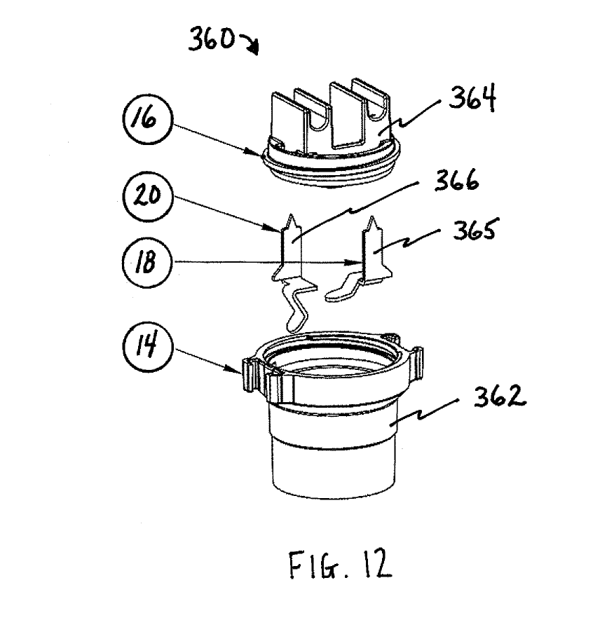

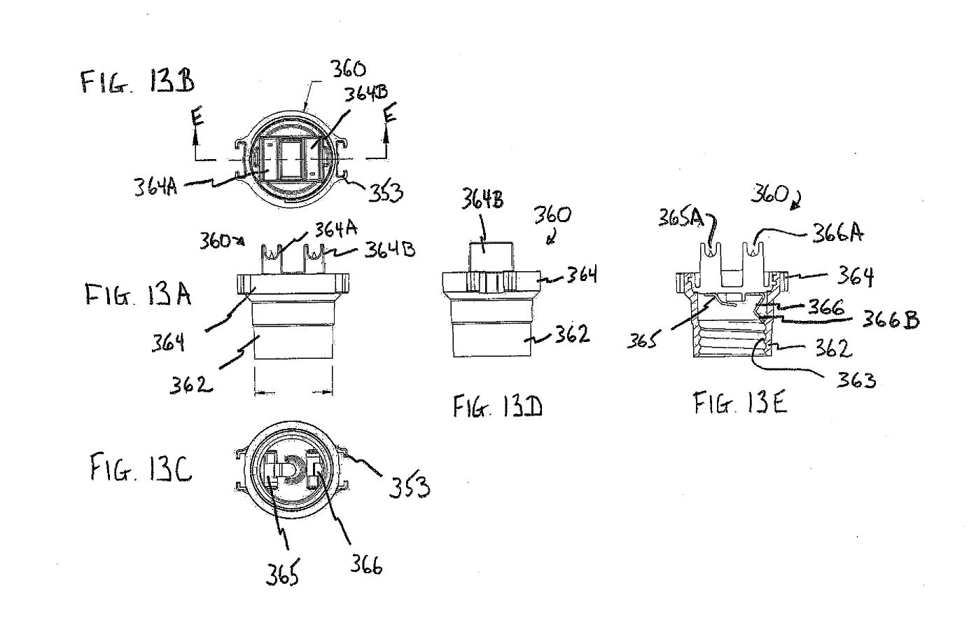

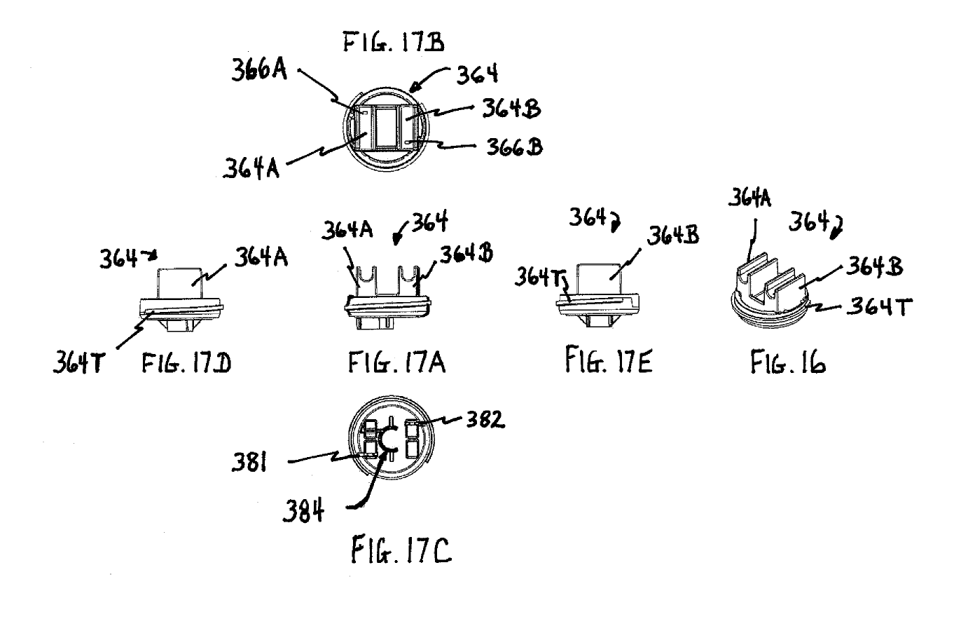

As shown in FIGS. 11A-11D, 12, 13A-13D, 14, 15A-15E, 16, 17A-17E, 18 and 20, the socket assembly 350 includes a bottom portion 352 and a top portion 354. Each of the bottom portion 352 and the top portion 354 define a corresponding locking mechanism 353 such that the top portion 354 is received within and engages the bottom portion 352 when pressed together in the direction indicated by the arrow Y. The bottom portion 352 defines a socket bottom assembly 360. The socket assembly 360 includes a socket base 362 and a socket cap 364. The socket cap 364 is threadedly received within the socket base 362. The socket cap 364 defines an external thread 364T and the socket base 362 defines a corresponding internal thread 362T. The socket base 362 further defines an internal thread 363 sized and configured to receive a light bulb therein such as LED bulb 226.

A positive contact 365 and a negative contact 366 extend through the socket cap 364 such that a terminal point 365A and a terminal point 366A respectively extend outwardly onto channels 364A and 364B of the socket cap 364. Thus, after the conductors 215 and 217 are positioned in the respective channels 364A and 364B, the top portion 354 is received within and engages the bottom portion 352 such that the locking mechanism 353 is engaged. Concurrently with the engagement of the locking mechanism 353, the terminal point 365A of positive contact 365 engages and is placed in electrical communication with the positive conductor 217, and the terminal point 366A of negative contact 366 engages and is placed in electrical communication with the negative conductor 215. Once the electrical connections are complete, the protective coating is applied to the lighting streamer 218 encapsulating the molded sockets 224 and the cable 219 together with the molded first connector 222 and the molded second connector 223.

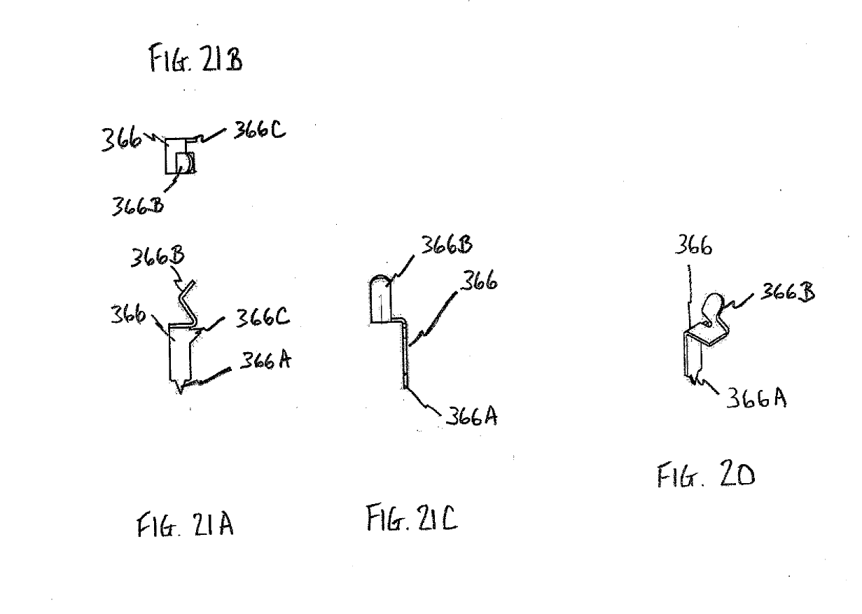

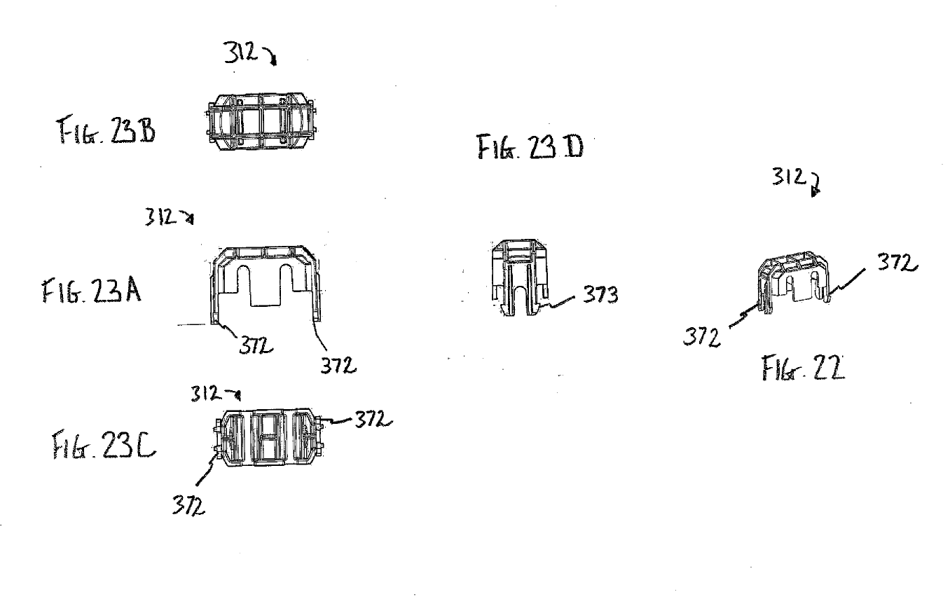

As further shown in FIGS. 10D, 14, 15B, 15C, 22 and 23A-23D, one embodiment of the locking mechanism 353 is a keyway and tab configuration 370 wherein the molded socket 224 top portion 312 defines one or more tabs or keys 372 and the socket base 362 defines a corresponding one or more keyways 374. The keyways 374 are sized and configured to receive and detachably engage the keys 372 therein. In one embodiment, two opposing keys 372 extend downward from the top portion 312 and each key 372 includes an outwardly extending flange 373. The keyways 374 define a channel 375 having opposing grooves 376 facing inwardly. When the top portion 312 is aligned with the socket base 362, the opposing keys 372 are biased inwardly toward each other and passed into and through the respective grooves 376 of the channel 375 such that the flanges 373 snap back into an unbiased position after passing through the respective grooves 376 and thereby removeably securing the top portion 312 to the socket base 362.

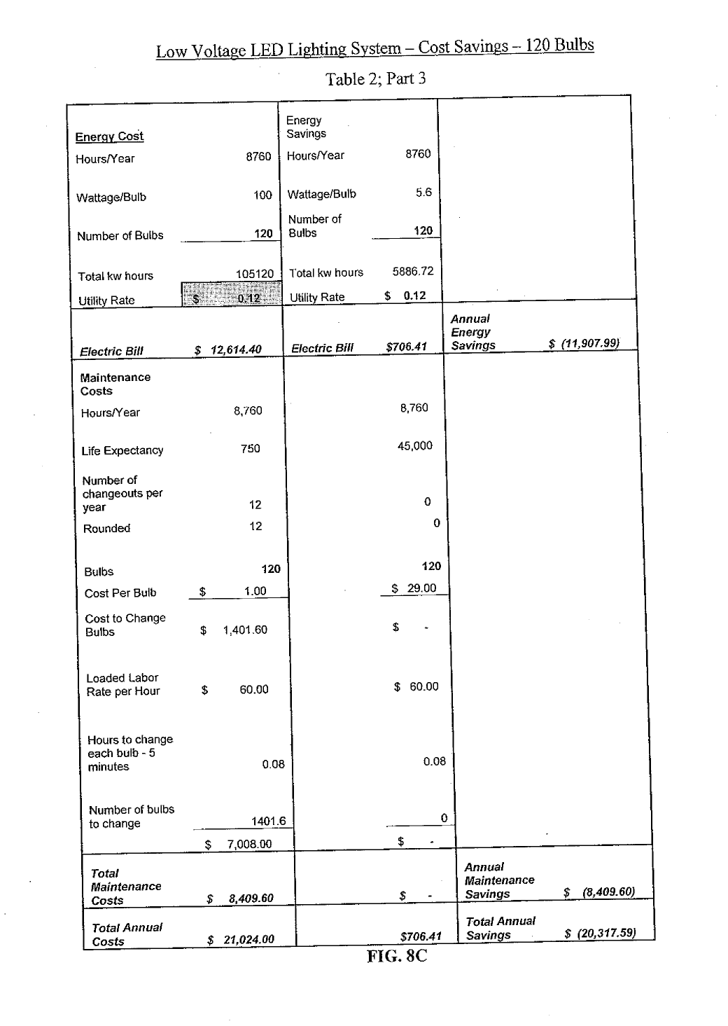

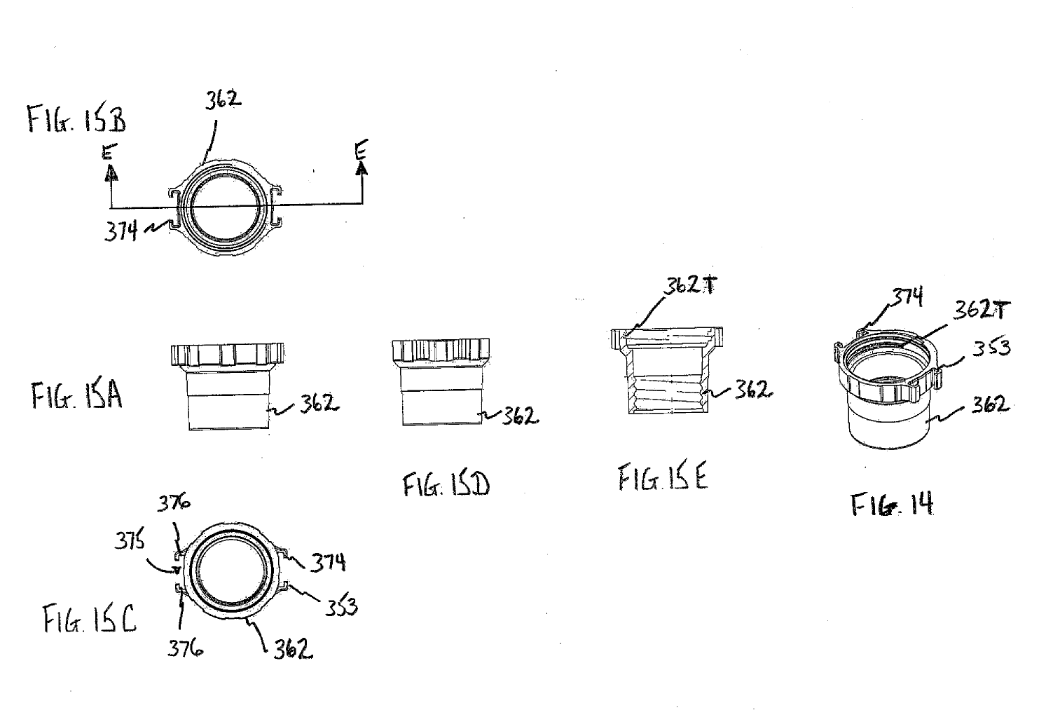

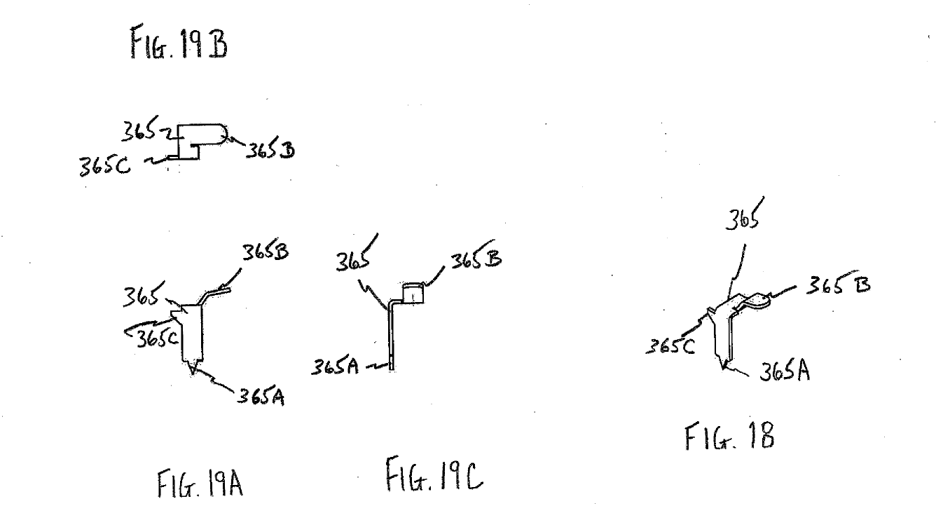

As further shown in FIGS. 13E, 17C, 18, 19A-19C, 20 and 21A-21C, the socket cap 364 defines a slot 381 for receiving the negative contact 365 therethrough and a slot 382 for receiving the positive contact 382 therethrough. Only the terminal points 365A and 366A extend completely through the respective slot 382 and 381. A flange 365C and 366C engages a portion of the respective slot 382 and 381 that does not extend through the socket cap 364 and retains each contact in its slot. The positive contact 365 defines a positive contact point 365B and the negative contact 366 defines a negative contact point 365B configured to place a light bulb, for example LED bulb 226, in contact with the respective positive conductor 217 and negative conductor 215 to complete a DC circuit. For example, positive contact point 365B is placed in electrical communication with the center contact located at the end of the ferrule 26C of the bulb 26 (FIG. 5) and the negative contact point 365B is placed in electrical communication with the side of the ferrule 26C of the bulb 26. The socket cap further defines a downwardly extending semi-circular flange 384 configured to substantially encompass and protect the contact point 365B.

In one embodiment, the bottom portion 352 and the top portion 354 of the socket assembly 350 are fabricated from a glass-filled polymer compound such as a glass-filled nylon composite. In one embodiment, the bottom portion 352 and the top portion 354 of the socket assembly 350 are fabricated from a thermoplastic polymers such as for example a polycarbonate.

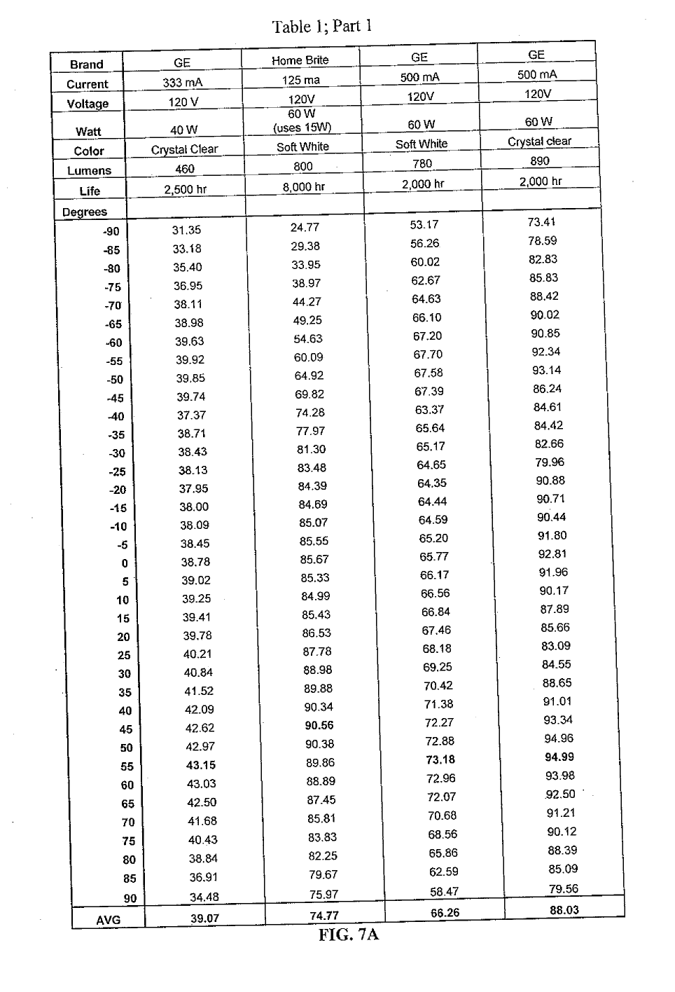

In one embodiment, LED light bulbs 26, 126 comprise eight (8) 3.5V LED's wired in series, and each comprises a 4.2 W/150 mA LED light bulb. The LED light bulbs may be manufactured at 100 mA or 200 mA depending on photometric requirements. At a nominal operating voltage of 28V, the bulbs are 6500° K cool white with a nominal life expectancy of 45,000 hours, and photometric output at 0 degrees is 105.75 candela. The light output of a number of different of incandescent bulbs was measured, tabulated, and compared to the light output of LED bulbs of the present invention. See FIGS. 7A-7D, Table 1, Parts 1-4 respectively, for a photometric chart providing a comparison of the performance of selected bulbs. For example, the light output of one of the selected incandescent bulbs, tabulated in the third data column of Table 1, Part 2, is the Crystal Clear® incandescent bulb, manufactured by General Electric Company, rated at 75 W, 625 mA, 120V with a life expectancy of 750 hours and photometric output at 0 degrees of 103.48 candela. Table 1, Part 4 represents LED light bulbs of the present invention. Further comparisons of the light output of the incandescent and LED bulbs tested are presented below with a listing of additional features and benefits.

In one embodiment, the AC/DC converter provides 20 A/120 VAC input conversion to four (4) 5 A/28 VDC secondary outputs; and also optionally provides 10 A/28 VDC output conversion to one or more outlets. Each secondary outlet is protected by a 5 A circuit-breaker. AC/DC converter can further include a custom 2-pin panel mount receptacle. The secondary outlets may be molded in thermoplastic preferably per FAA 150-5345/26B Rev C specifications. The secondary outlets preferably are designed per FAA L823-Style 7. Moreover, the secondary outlets preferably are waterproof to 20 PSI per FAA Specifications such that water may not enter past bare pins nor enter the cable jacket, up to 20 PSI, when the product is unassembled. Similarly, the molded connectors are waterproof up to 20 PSI with no water or other elements entering the mating point when assembled. Each secondary outlet is rated 20 A at 600V. The secondary outlets are designed and tested to have less than 0.2 micro Amps of leakage when tested in water at 5,000 Volts for a 1 minute cycle per FAA Specifications.

The AC/DC converter 12 is designed to provide DC power to multiple lighting streamers that can be daisy-chain connected. Any one of a variety of options may be selected to provide the appropriate AC-to-DC power conversion. The AC/DC converter 12 can comprise a molded box in thermoplastic or like material that is IP64 outdoor-rated and suitable for rugged environments such as for heavy construction. Alternatively, the AC/DC converter 12 may comprise an enclosure fabricated from a suitable metal. The AC/DC converter 12 may have an input defined by a molded 3M20, a molded 3MT20, or a molded or assembled 20 A/120 VAC male plug. The output can include one panel mount receptacle rated 20 A, 28 VDC, or two panel mount receptacles rated 10 A, 28 VDC each, or four panel mount receptacles rated 5 A, 28 VDC each. In addition, the AC/DC converter 12 may be permanently molded in line with the lighting streamer 18 for use in confined spaces. The AC/DC converter 12 requires a maximum of three (3) amps and the molded in line converter box is provided as an integral part of the lighting streamer 18.

The Low Voltage LED Lighting System according to the present invention includes many features that provide advantages over prior art lighting streamer systems. One advantage relates to the amount of lights that can be powered with the 20 A, 120V power source. As described above, at the loading of each circuit of the prior art system at 80% max or 16 A, only 26 bulbs at 75 W, 625 mA, 120V may be safely operated. In contrast, by using a Low Voltage-LED Lighting System according to the present invention, over 150 LED bulbs may be safely operated using the same power source.

Another advantage of the Low Voltage LED Lighting System according to the present invention over prior art lighting streamer systems relates to a power savings. For each incandescent application, twenty-six (26) bulbs at 75 W each provide a total wattage of 1,950 W. Assuming a total KW charge of $0.12 per hour and full time operation for 30 days (720 hours), the cost would total $168.48 (26×75 W=1950 W; 1950 W×720 hours=1,404 kwhr; 1,404 kwhr×$0.12/kwhr). If using 26 Low Voltage LED bulbs that are rated 4.2 W, 150 mA, 28 VDC each, for the same time of operation, the cost would be $9.43 (26×4.2 W=109.2 W; 109.2 W×720 hours=78.62 kwhr; 78.62 kwhr×$0.12/kwhr). This represents savings exceeding 90%.

Yet another advantage of the Low Voltage LED Lighting System according to the present invention over prior art lighting streamer systems relates to a maintenance savings. Assuming a loaded rate of $60/hour, and that a standard 75 W bulb has a life expectancy of 750 hours, and that it takes an hour to change out 26 bulbs, and that the lighting streamers are on full time, the bulbs may need to be changed every 31.25 days at a cost of $60. The life expectancy of the LED Bulb is 45,000 hours. Based on nominal ratings, the incandescent bulbs may need to be changed 60 times before the LED bulbs.

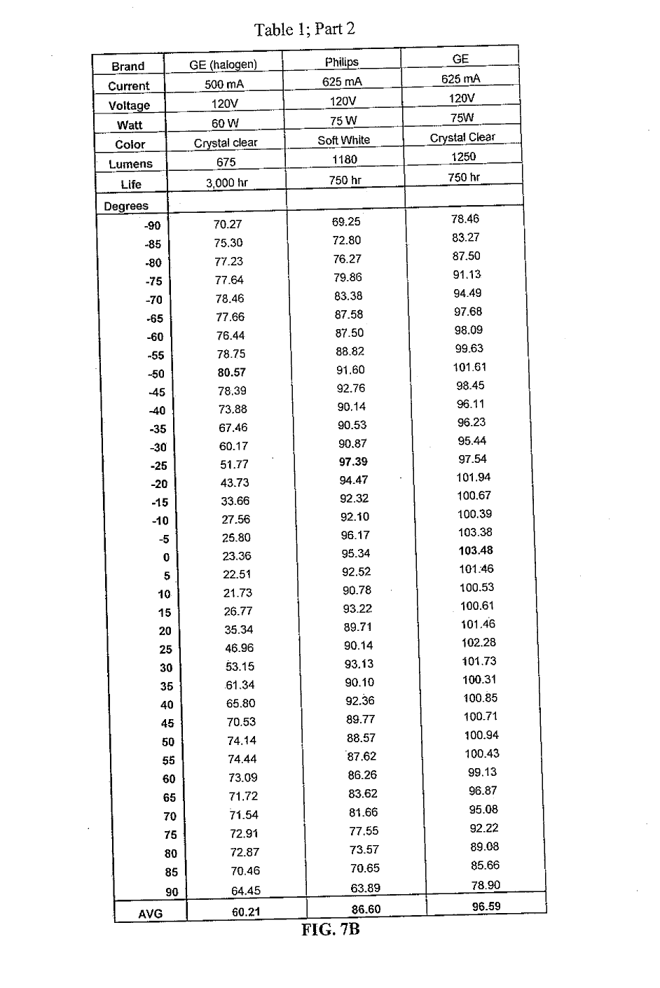

See FIGS. 8A-8C, Table 2, Parts 1-3 respectively, for further details regarding the savings that may be achieved as a result of using the Low Voltage LED Lighting System according to the present invention. In Table 2, Part 1, a Low Voltage LED Lighting System using 120 2.8 W LED bulbs is compared to a system using 120 60 W bulbs. The Low Voltage LED Lighting System provides an annual energy savings exceeding $7000; and an annual maintenance savings of about $3000. Accordingly, a total savings exceeding $10,000 is achieved.

In Table 2, Part 2, a Low Voltage LED Lighting System using 120 4.2 W LED bulbs is compared to a system using 120 75 W bulbs. The Low Voltage LED Lighting System provides an annual energy savings of about $9000; and an annual maintenance savings of about $9000. Accordingly, a total savings exceeding $17,500 is achieved.

In Table 2, Part 3, a Low Voltage LED Lighting System using 120 5.6 W LED bulbs is compared to a system using 120 100 W bulbs. The Low Voltage LED Lighting System provides an annual energy savings of about $12,000; and an annual maintenance savings exceeding $8000. Accordingly, a total savings exceeding $20,000 is achieved.

For some heavy constructions activities, OSHA requires any circuit that is rated over 30V be GFCI protected. Adding GFCI protection has proven to be very costly. A low voltage system according to the present invention may be operated on a circuit rated at less than 30V; accordingly, it will not be necessary to incorporate GFCI protection per OSHA regulations directed at circuits rated over 30V. In addition, each lighting socket of a low voltage system according to the present invention selectively includes a means for providing weather and other environmental protection while allowing for any heat generated by the LED bulbs to be exhausted. Optionally, the AC/DC converter of a low voltage system according to the present invention selectively includes a power supply/rectifier thereby eliminating such need at each light bulb. A low voltage system according to the present invention can be selectively equipped with dedicated male and female plugs that can only engage the AC/DC Converter or another Low Voltage-LED Streamer. This allows for a dedicated circuit and prevents damage to the product or the operator from plugging into the incorrect circuit or circuit load.

One embodiment of a low voltage LED lighting system of the present invention is designed for use with solar power. Typically, a solar panel provides 380 VDC nominal and such power is inverted to provide 120 VAC to a power/breaker box. In the low voltage LED lighting system of the present invention, the solar power is carried to a step-down transformer for converting 380 VDC to 28 VDC. The solar power thereby provides power for the LED bulbs rated at 28 VDC. Typically, the inversion of 380 VDC to 120 VAC causes losses up to 25%. Such losses are increased by using conventional off-the-shelf LED bulbs. In contrast, there is minimal loss associated with the use of a step-down DC-to-DC transformer. Accordingly, the low voltage LED lighting system of the present invention enhances the use of solar power for lighting systems and makes solar power more viable cost-beneficial option.

There are numerous additional benefits and advantages regarding the use of a Low Voltage LED Lighting System in accordance with the present invention. Moreover, a Low Voltage LED Lighting System in accordance with the present invention may selectively include a number of preferred optional embodiments as further described herein.

The lighting streamer 18 of the lighting system 10 selectively may define or include any one or any combination of the following features and benefits:
Sockets that are permanently molded on UL Rated 12/2 SOOW Cable;
Cable and molded sockets that are resistant to Oil and Water;
Cable and each molded socket that are rated for 600 VAC and 90° C.;
An outer jacket of the 2-conductor cable that is stripped back for assembly of the socket to the cable;
Each of the two individual #12AWG wires that are also stripped and prepared for solder attachment;
Sockets that are constructed using a medium base Edison-style screw shell;
Sockets that are constructed with a phenolic base disk;
Sockets that are constructed with a brass center contact;
Sockets that are constructed with a metal crush ring that is integrally molded into the socket and designed to protect the screw shell from damage from a crushing action and to give it structural integrity;
A Wire lead using 14/1 Wire that is soldered to the center contact for positive connection on one end, that same wire also being soldered to one of the wires of the 2 conductor cable;
A Wire lead using 14/1 Wire that is soldered to the outside of the screw shell for connection on one end for positive connection, that same wire also being soldered to one of the wires of the 2 conductor cable;
The internal wires of the 12/2 Cable that are never severed to maintain structural integrity, instead these wires are stripped and the wire leads are molded (it is noteworthy that substantially all lower cost versions mold or assemble 5′ sections of cable to make a multi socket streamer, and these streamers are much weaker and of much lower quality);
Sockets that are molded in neoprene based thermoset rubber material;
Molded connectors that are molded in Neoprene based thermoset rubber material;
Molded streamer sockets having a ground tab instead of a ground ring wherein the tab is permanently molded into the socket;
Male and Female that connectors are molded per FAA 150-5345/26B Rev C specifications;
Male and Female molded connectors that are designed per FAA L823-Style 1 (male) and Style 7 (female);
Male and Female molded connectors that are completely waterproof to 20 PSI per FAA Specifications such that water will not enter past bare pins nor enter cable jacket up to 20 PSI when product is unassembled, and connectors that are waterproof up to 20 PSI with no water or other elements entering the mating point when assembled up to 20 PSI;
Male and Female molded connectors that are rated 20 A at 600V; and
Male and Female molded connectors that are designed and tested to have less than 0.2 micro Amps of leakage when tested in water at 5,000 Volts for a 1 minute cycle per FAA Specifications.

The LED light bulbs 26, 126 of the lighting system 10, 100 selectively may define or include any one or any combination of the following features and benefits:
Wire termination of red (Positive) wire from contact in screw shell to first LED;
Wire termination of black (Negative) wire from outside of screw shell to last LED;
LED's that are wired in Series;
LED's that are rated 3.5 VDC each;
Having 8 LED's with cumulative voltage from wiring in series at 28 VDC;
2.8 W Bulbs having a current limiting resistor for rating at 100 mA;
4.2 W Bulbs having a current limiting resistor for rating at 150 mA;
5.6 W Bulbs having a current limiting resistor for rating at 200 mA;
2.8 W Bulbs having a max candela output of 78.18, this exceeds the max candela output of a GE Soft White 60 W, 120 VAC Bulb at 500 mA with max candela at 73.18 (See the third data column of Table 1, Part 1);
4.2 W Bulbs having a max candela output of 105.83, this exceeds the max candela output of a Philips Soft White 75 W, 120 VAC Bulb at 625 mA with a max candela at 97.39 (See the second data column of Table 1, Part 2);
5.6 W Bulbs having a max candela output of 140.12, this exceeds the max candela output of a GE Soft White 100 W, 120 VAC Bulb at 875 mA;
OSHA Compliant;
Water Resistant to IP 67;
Operates at cooler temperatures than standard incandescent bulbs therefore are safe to the touch;
LED Array pattern in 1.5″ Diameter Circle with each of (8) LEDs equidistant from each other to optimize light distribution and thermal management;
Fail safe design in the event of improper installation to a 120 VAC power supply;
No harmonics present due to DC input to bulb, no need for rectifier for conversion in bulb (which causes harmonics);
Metal clad printed circuit boards designed for maximum thermal efficiency;
Designed to be buoyant—bulb can float (ideal for marine atmosphere);
Aluminum has a chemical film coating for extra durability;
Polycarbonate housing for maximum shock resistance;
Shock Resistance tested with drop test at 10′;
Will operate with maximum light output at input voltage between 25 to 28 VDC, which eliminates any problems associated with voltage drop when plugging lines of streamers into each other;
Bulb Color Temperature is 6500 Cool White; and
Bulb weight is 155 grams.

The AC/DC converter 12, 112 of the lighting system 10, 100 selectively may define or include any one or any combination of the following features and benefits:
Power Supply—Input 20 A, 120 VAC convert to 20 A, 28 VDC;
A plurality of outlets to provide DC voltage to devices;
(4) Secondary Outlets, each 5 A, 28 VDC;
Each secondary outlet is circuit breaker protected at 5 A;
EL Steel Aluminum Enclosure that measures 16″×16″×10.5″;
Enclosure Weight is 44 lbs;
Enclosure is rated IP64;
Primary input 16 Amp panel mounted circuit breaker;
(5) Dust covers to protect from rough environment;
Flat Control Panel measuring 13″×13″;
(4) Urethane bumpers—1″ Height×1″ Diameter to lift bottom surface from ground to protect from environment;
(3) Stainless Steel Pull Handles 6″×1.5″;
115V Fan designed to turn on and cool the unit based on thermal conditions, powered by low current from the primary input;
(2) Metal Fan Guards 120 mm;
4″ Fan Bracket;
¾″ Cord Grip Connector for primary input with washer;
(6) Terminal Block, 4 Position, Din Style;
(4) 5 A Circuit Breakers for the Secondary Side;
Secondary Output Breakers are thermal breakers;
7′ Input cord on UL Rated 12/3 SOOW Cable;
Steel Aluminum Outlet Bracket for 4 outlets;
Secondary Outlets that are molded in Thermoplastic;
Secondary Outlets that are molded per FAA 150-5345/26B Rev C specifications;
Secondary Outlets that are designed per FAA L823-Style 7;
Secondary Outlets that are completely waterproof to 20 PSI per FAA Specifications such that water will not enter past bare pins and enter cable jacket up to 20 PSI when product is unassembled, and connectors that are waterproof up to 20 PSI with no water or other elements entering the mating point when assembled up to 20 PSI;
Each Secondary Outlet being rated 20 A at 600V;
Secondary Outlets that are designed and tested to have less than 0.2 micro Amps of leakage when tested at 5,000 Volts for a 1 minute cycle per FAA Specifications;
Output voltage that can be adjusted to range from 24 VDC to 30 VDC;
Input voltage that ranges from 90 to 130 VAC at 60 Hz;
Model that can also be used for 240 VAC by manually selecting that option on internal circuitry of Power Supply;
Maximum input Amps at 20 A;
Output Voltage Range 28.0 VDC to 28.2 VDC;
Rated Power at 480 W;
Start Up/Set Up Rise Time is 1200 ms at 120 VAC with full load (40 ms at 230 VAC);
Has constant current limiting overload protection and recovers automatically after fault is removed;
Overvoltage protection on secondary is designed to shut down between 30-36 VDC, will repower upon recovery;
Over Temperature protection and will shut down, will repower upon recovery;
Working Humidity of 0-100%, will perform in any range of humidity;
Withstand Voltage is I/P-O/P: 3KVAC, I/P-FG: 1.5KVAC, O/P-FG: 0.5KVAC;
Isolation Resistance of I/P-O/P, I/P-FG: 100 Mega Ohms/500 VDC/25 degrees C./70% RH; and
Operating temperature range of −15 F to 160 F (−26 C to 71 C).

The lighting system 10, 100 may provide such features and benefits in a number of applications including, but not limited, the uses listed below.
An AC/DC Converter with 20 A, 120 VAC input and converts that energy to the following secondary output configurations:
   1 outlet at 20 A, 28 VDC;
   2 outlets at 10 A, 28 VDC each; and
   8 outlets at 2.5 A, 28 VDC each.
Lighting Streamers can comprise molded thermoplastic and be molded onto 12/2 SEOW Cable.
Lighting Streamers can be molded on smaller sized (AWG), 2 conductor cable.
Lighting Streamers can be assembled using a pre-mold where internal wires are pierced and snapped into an assembly, and which pre-mold will become an integral part of the socket material after molding.
System can be adapted to retrofit existing Lighting Streamers, and can include adapters that have the standard 2-wire male connection that is designed to plug into the convertor on one end, and a 3-wire connector on the other end. One example is an adapter with a Style 1 Male connector on one end and a Navy Grade molded 3-wire Female connector on the other end (Ref 3F20, 3FT20).
Conversion of any input voltage from 110 VAC to 240 VAC Single Phase to 28 VDC for Temporary Lighting.
Conversion of 120 VAC to any DC Voltage between 12 to 30 VDC.
Bulbs designed with miniature base so not to confuse them with standard Incandescent AC circuits.
Light Bulb base designed with dedicated configuration like twist lock, bayonet snap in, etc.
LED Bulbs can be designed for parabolic aluminized reflector (“PAR) lamps such as for example PAR 38 type spotlight applications.
LED Bulbs can be designed with tubular design, equivalent to T4, T5, T12 and other size fluorescent tubes.
LED bulbs, tubes, PAR 38 or other lights can operate at temperatures greater than and lesser than 6500° K dependent upon the specified application for the LED light.
LED bulbs, tubes, PAR 38 or other lights can operate with alternate colors in addition to cool white dependent upon the specified application for the LED light.
Lighting Streamers can be assembled in sections using crimp or other reliable connection methods to tie two wires on main line into the center contact and screw shell and then over-molded into one integral socket.
Y-Junctions can be used to split the energy supply on the secondary side of the AC/DC Converter which allows for flexibility in set-up and can minimize the voltage drop.
Provide Lighting Streamers with specially designed guards that lock into place and protect the bulb from theft, as well as damage from the atmosphere.
Lighting streamer with any number of sockets molded or assembled onto 2-conductor or 3-conductor cable for lighting of multiple bulbs on a string of lights.
AC/DC Converter can be made out of different material (e.g., plastic or metal such as for example aluminum) to be more lightweight and portable.
AC/DC Converter can be designed with breather elements to vent the heat instead of a fan.
AC/DC Converter can be designed with lower current capacity on the secondary (for example—(2) 5 amp outlets) for those that have smaller projects.
Connectors on the end of streamers can have a different configuration or style than the FAA Style connectors, for example—Snap into place for positive lock or twist lock connectors.

The lighting system 10, 100 also may include or provide the features and benefits listed below.
A super efficient LED Lighting system that is designed to run as a DC Lighting system so that inefficient conversion is not needed at each socket wherein such system is designed to plug into standard 120 VAC power source and convert voltage to 28 VDC to run temporary lighting streamers.
An AC/DC Converter that has 20 A, 120 VAC input and converts that energy to 4 outlets of 5 A, 28 VDC output for use to power Temporary Lighting.
A Temporary Lighting Streamer with molded sockets on 12/2 Cable with FAA Style L823 Male and Female connectors designed to operate on a 28 VDC circuit.
An LED Light Bulb designed with (8) 3.5V LEDs wired in series, that takes 28 VDC input to power at the following sizes:
   2.8 W at 100 mA;
   4.2 W at 150 mA; and
   5.6 W at 200 mA.
Lighting Streamers and Bulbs designed for 28 VDC which is not a shock hazard per OSHA (under 30V), thereby providing the safest system currently available.
Do not need GFCI because the system is not a shock hazard at 28 VDC thereby achieving cost savings by eliminating GFCI and cost savings by not having to run redundant Emergency Lighting Systems.
Energy Savings per bulb compared to Incandescent Bulbs:
   60 W Incandescent equivalent is 2.8 W=95% savings;
   75 W Incandescent equivalent is 4.2 W=94% savings; and
   100 W Incandescent equivalent is 5.6 W=94% savings
A Bulb that has a life expectancy of 45,000 hours.
Maintenance Savings:
   2.8 W has a 45,000 hour life, the equivalent 60 W incandescent has a 2,000 hour life, the incandescent light bulb will have to be changed 22 times before the LED light bulb; and
   4.2 W has a 45,000 hour life, the equivalent 75 W incandescent has a 750 hour life, the incandescent light bulb will have to be changed 60 times before the LED light bulb.
2.8 W Bulb has max candela output of 78.18, which exceeds the max candela output of a GE Soft White 60 W, 120 VAC Bulb at 500 mA with max candela at 73.18.
4.2 W Bulb has max candela output of 105.83, which exceeds the max candela output of a GE Crystal Clear 75 W, 120 VAC Bulb at 625 mA with a max candela at 103.48.
5.6 W Bulb has max candela output of 140.12, which exceeds the max candela output of a GE Soft White 100 W, 120 VAC Bulb at 875 mA.
Energy Savings as compared to an Off the Shelf LED Bulb that is designed to be powered off of 120 VAC and has an AC/DC Converter and rectifier built into it:
   13 W Off the Shelf LED is equivalent to a 2.8 W LED Bulb=78% Savings
AC/DC conversion generates heat, performed at each bulb in prior art systems and such conversions runs hot; in contrast, the low voltage LED lighting system converts the energy once, near the power source, and heat is managed efficiently at one and only conversion point.
Bulbs burn cool and run efficiently because no conversion or rectifier is built into the bulb. In climate-controlled atmospheres, this yields additional savings because generally air conditioner units are used to cool a facility that has excess heat generated by bulbs.
No harmonic distortion at bulb due to conversion and rectifier, bulbs don't hum and instead burn efficiently
Off the Shelf LED Bulbs are rated at 13 W with less than 3 W going to lighting and the rest getting consumed in the Conversion (rectifier). In contrast, power for the LED bulbs of the present invention is directed to lighting wherein no power is wasted.
Converter is designed for IP64 rating—durable and waterproof.
Converter has Secondary Outlets that are molded per FAA 150-5345/26B Rev C specifications and are designed per FAA L823-Style 7.
Converter has Secondary Outlets that are completely waterproof to 20 PSI per FAA Specifications, water will not enter past bare pins and enter cable jacket up to 20 PSI when product is unassembled, connectors are waterproof up to 20 PSI with no water or other elements entering the mating point when assembled up to 20 PSI.
Converter has Secondary Outlets that are designed and tested to have less than 0.2 micro Amps of leakage when tested at 5,000 Volts for a 1 minute cycle per FAA Specifications.
Converter has Overvoltage protection on secondary is designed to shut down between 30-36 VDC, will repower upon recovery.
Converter has Over Temperature protection and will shut down, will repower upon recovery.
Lighting Streamer sockets are assembled such that wire jumpers are soldered from each of the two main cable wires on one end, and to the center contact and screw shell on the other end which provides additional structural integrity.
Lighting Streamer Male and Female connectors are molded per FAA 150-5345/26B Rev C specifications and are designed per FAA L823-Style 1 (male) and Style 7 (female).
Lighting Streamer Male and Female molded connectors are completely waterproof to 20 PSI per FAA Specifications, water will not enter past bare pins and enter cable jacket up to 20 PSI when product is unassembled, connectors are waterproof up to 20 PSI with no water or other elements entering the mating point when assembled up to 20 PSI.
Lighting Streamer Male and Female molded connectors are designed and tested to have less than 0.2 micro Amps of leakage when tested at 5,000 Volts for a 1 minute cycle per FAA Specifications.
Light Bulbs are completely waterproof to IP67 Rating for operation in 1 meter of water.
Light Bulbs have an LED Array pattern in 1.5″ Diameter Circle with each of (8) LEDs equidistant from each other to optimize light distribution and thermal management.
Bulbs are designed to be buoyant—bulb can float (ideal for marine atmosphere).
Bulbs are designed to withstand a 10′ drop test.
Bulbs are designed to withstand a vibration test.
Lighting Streamers are designed to be daisy-chained together.
Bulbs are designed to power to maximum light output with forward voltage levels as low as 25 VDC.
Soldered connections at sockets and molded sockets are designed to provide 100% continuity and minimize voltage drop as the voltage goes down the line, this allows more lights to be put on each of the secondary outlets and therefore maximizes the light output per each power input source.
Prior art lighting systems require local power taps be made available at a construction site which is costly and needs to be maintained. The low voltage LED lighting system of the present invention can power anywhere from 6 to 12 times the amount of light bulbs with the same 120 VAC power source, which yields a substantial logistical savings in providing power circuits for lighting.

Although this invention has been shown and described with respect to the detailed embodiments thereof, it will be understood by those of skill in the art that various changes may be made and equivalents may be substituted for elements thereof without departing from the scope of the invention. In addition, modifications may be made to adapt a particular situation or material to the teachings of the invention without departing from the essential scope thereof. Therefore, it is intended that the invention not be limited to the particular embodiments disclosed in the above detailed description, but that the invention will include all embodiments falling within the scope of the appended claims.

What is claimed is:

1. A lighting streamer for a low voltage LED lighting system, the lighting streamer comprising:
a cable having a first end and a second end, the cable including a positive conductor and a negative conductor;
a first connector positioned on and in electrical communication with the first end of the cable;
a second connector positioned on and in electrical communication with the second end of the cable;
at least one socket assembly positioned between the first connector and the second connector and in electrical communication with the cable, the socket assembly defining a top portion and a bottom portion which when assembled, pierce the positive conductor and the negative conductor and place a positive contact in electrical communication with the positive conductor and place a negative contact in electrical communication with the negative conductor, each of the at least one socket assemblies being configured to receive an LED bulb therein; and
a protective coating encapsulating the at least one socket assembly.

2. The lighting streamer for a low voltage LED lighting system of claim 1, wherein the protective coating further encapsulates the cable.

3. The lighting streamer for a low voltage LED lighting system of claim 1, wherein the at least one socket assembly further comprises:
a locking mechanism configured to releasably detach the top portion from the bottom portion.

4. The lighting streamer for a low voltage LED lighting system of claim 3, the locking mechanism comprising:
at least two keys defined in the top portion; and
at least two keyways defined in the bottom portion;
wherein the keyways are sized and configured to receive and detachably engage the keys therein.

5. The lighting streamer for a low voltage LED lighting system of claim 1 wherein the bottom portion of the at least one socket assembly further comprises:
a socket base;
a socket cap;
a positive contact terminal point of the positive contact extending through the socket base toward the socket cap and in electrical communication with the positive conductor; and
a negative contact terminal point of the negative contact extending through the socket base toward the socket cap and in electrical communication with the negative conductor.

6. The lighting streamer for a low voltage LED lighting system of claim 5, further comprising:
a first slot defined in the socket cap configured for receiving the positive contact therethrough; and
a second slot defined in the socket cap configured for receiving the negative contact therethrough.

7. The lighting streamer for a low voltage LED lighting system of claim 1, wherein the top portion and the bottom portion of the at least one socket assembly are fabricated from a glass-filled polymer compound.

8. The lighting streamer for a low voltage LED lighting system of claim 1, wherein the top portion and the bottom portion of the at least one socket assembly are fabricated from a thermoplastic polymer.

9. The lighting streamer for a low voltage LED lighting system of claim 1, further comprising:
an LED light bulb positioned in and in electrical communication with at least one of the at least one socket assemblies.

10. A lighting streamer for a low voltage LED lighting system, the lighting streamer comprising:
a cable having a first end and a second end, the cable including a positive conductor and a negative conductor;
a first connector positioned on and in electrical communication with the first end of the cable;
a second connector positioned on and in electrical communication with the second end of the cable;
a plurality of socket assemblies positioned between the first connector and the second connector and in electrical communication with the cable, each of the socket assemblies defining a top portion and a bottom portion which when assembled, pierce the positive conductor and the negative conductor and place a positive contact in electrical communication with the positive conductor and place a negative contact in electrical communication with the negative conductor, each of the socket assemblies being configured to receive an LED bulb therein, each of the socket assemblies comprising,
a socket base,
a socket cap,
a positive contact terminal point of the positive contact extending through the socket base toward the socket cap and in electrical communication with the positive conductor,
a negative contact terminal point of the negative contact extending through the socket base toward the socket cap and in electrical communication with the negative conductor,
a first slot defined in the socket cap configured for receiving the positive contact therethrough, and
a second slot defined in the socket cap configured for receiving the negative contact therethrough;
a locking mechanism configured to releasably detach the top portion from the bottom portion; and
a protective coating encapsulating each of the socket assemblies.

11. The lighting streamer for a low voltage LED lighting system of claim 10, wherein the protective coating further encapsulates the cable.

12. The lighting streamer for a low voltage LED lighting system of claim 10, the locking mechanism comprising:
at least two keys defined in the top portion; and
a corresponding at least two keyways defined in the bottom portion;
wherein the keyways are sized and configured to receive and detachably engage the keys therein.

13. The lighting streamer for a low voltage LED lighting system of claim 10, wherein the top portion and the bottom portion of the at least one socket assembly are fabricated from a glass-filled polymer compound.

14. The lighting streamer for a low voltage LED lighting system of claim 10, wherein the top portion and the bottom portion of the at least one socket assembly are fabricated from a thermoplastic polymer.

15. A low voltage LED lighting system comprising:
a power supply;
an AC/DC converter in electrical communication with the power supply;
a cable having a first end and a second end, the cable including a positive conductor and a negative conductor, the cable in electrical communication with the AC/DC converter;
a first connector positioned on and in electrical communication with the first end of the cable;
a second connector positioned on and in electrical communication with the second end of the cable;
a plurality of socket assemblies positioned between the first connector and the second connector and in electrical communication with the cable, each of the socket assemblies defining a top portion and a bottom portion which when assembled, pierce the positive conductor and the negative conductor and place a positive contact in electrical communication with the positive conductor and place a negative contact in electrical communication with the negative conductor, each of the socket assemblies being configured to receive an LED bulb therein, each of the socket assemblies comprising,
a socket base,
a socket cap,
a positive contact terminal point of the positive contact extending through the socket base toward the socket cap and in electrical communication with the positive conductor,
a negative contact terminal point of the negative contact extending through the socket base toward the socket cap and in electrical communication with the negative conductor,
a first slot defined in the socket cap configured for receiving the positive contact therethrough, and
a second slot defined in the socket cap configured for receiving the negative contact therethrough;
a locking mechanism configured to releasably detach the top portion from the bottom portion; and
a protective coating encapsulating each of the socket assemblies.

16. The low voltage LED lighting system of claim 15 wherein the power supply comprises a 120 VAC power supply.

17. The low voltage LED lighting system of claim 15 wherein the power supply comprises a circuit rated at less than 30V.

18. The low voltage LED lighting system of claim 15 wherein the AC/DC converter comprises a rectifier.

19. The lighting streamer for a low voltage LED lighting system of claim 10, further comprising:
an LED light bulb positioned in and in electrical communication with at least one of the plurality of socket assemblies.

20. The low voltage LED lighting system of claim 15, further comprising:
an LED light bulb positioned in and in electrical communication with at least one of the plurality of socket assemblies.
